(19) United States
(12) Patent Application Publication
(10) Pub. No.: US 2016/0060907 A1
(43) Pub. Date: Mar. 3, 2016

(54) LOCK AND SHACKLE APPARATUS THEREOF

(71) Applicant: Mainco Group Limited

(72) Inventor: Yeung On Paul Tsui, HONG KONG (HK)

(73) Assignee: MAINCO GROUP LIMITED

(21) Appl. No.: 14/809,817

(22) Filed: Jul. 27, 2015

(30) Foreign Application Priority Data
Sep. 3, 2014 (CN) 201420506704.1

(51) Int. Cl. E05B 67/22

(52) U.S. Cl. CPC E05B 67/22

(57) ABSTRACT

Disclosed are a lock and a shackle apparatus thereof. The lock includes a lock body, and the lock body is provided with a shackle opening and a locking hole. The shackle apparatus includes a lock hook and a hook bolt while one end of the lock hook being adapted to be locked in the locking hole when the lock is locked. The lock body is further provided with a hook bolt base for accommodating the hook bolt. The hook bolt base being in communication with the shackle opening.

### FIELD OF THE INVENTION

The present utility model relates to a lock, and in particular, to a padlock and a shackle apparatus thereof.

### BACKGROUND OF THE INVENTION

Lock is a commonly used article. There are various types of locks, including padlocks, vehicle locks, pin tumbler door locks, mortise door locks etc., among which the padlock is the most widely used lock with a longest history. An existing padlock generally includes a lock body (or referred to as a lock case), a lock hook (or referred to as shackle) and a lock cylinder assembly. For example, Chinese utility model patent no. CN203050300U discloses a laminated padlock including a lock case, a lock cylinder assembly disposed in the lock case and a shackle connected to the lock case and disposed in the lock cylinder assembly where locking and unlocking are controlled, where a plurality of separators is stacked and fixed to the periphery of the lock case. In another example, Chinese utility model patent no. CN202401852U discloses a padlock, in particular, a padlock including a lock case, a shackle, lock holes, a lock cylinder, a lock cylinder base, an eccentric shank and ball bearings etc. The lock cylinder and the lock cylinder base are disposed at the lower end inside the lock case with the eccentric shank disposed at the upper end inside the lock case. A key hole is provided at the lower end of the lock cylinder and a shifting block drivably coupled with the eccentric shank is disposed at the upper end of the lock cylinder. The ball bearings are respectively disposed at two sides of the eccentric shank and slidable according to the rotation of the eccentric shank. The lock holes are located on the outer side of the ball bearings. A longer end and a shorter end of the shackle are respectively inserted into their corresponding lock holes engaged with the ball bearings.

However, for all existing locks, the shackle is mounted in a shackle recess of the lock body in the process of assembling the lock body. As the shackle is required to be fitted to other components of the lock during assembly, the assembling process of such locks is relatively time-consuming and labor-consuming. Particularly, the assembling of laminated padlocks, which have lock body formed by multiple metal sheets and a complex structure, requires the shackle and the lock body to be assembled simultaneously which is time-consuming and labor-consuming and often results in a high defect rate.

### SUMMARY OF THE INVENTION

An objective of the present invention is to provide a lock and a shackle apparatus thereof, in which the shackle can be mounted after the lock body is assembled in accomplishing the assembly of the lock.

To achieve the foregoing objective, the present invention provides a shackle apparatus for a lock. The lock including a lock body is provided with a shackle opening and a lock opening, wherein the shackle apparatus includes a lock hook and a hook bolt. One end of the lock hook being adapted to be locked in the lock opening when the lock is locked.

The lock body is further provided with a hook bolt base for accommodating the hook bolt. The hook bolt base being connected with the shackle opening.

The hook bolt and the lock hook are configured in such a manner that after the lock body is assembled, the other end of the lock hook can be inserted into the shackle opening and fitted to the hook bolt so that the lock hook is rotatably connected to the lock body. The lock hook can move up and down after being rotated by a certain angle.

Preferably, the hook bolt is an elastic member such that when the lock hook is inserted into the shackle opening, the hook bolt is elastically deformed allowing the insertion of the lock hook and recovers from the deformation after the lock hook is inserted, thereby retaining the lock hook in the shackle opening.

In a preferred embodiment, the end of the lock hook that is accommodated in the shackle opening is provided with a hook bolt slot and an eccentric structure so that when the lock hook is inserted into the shackle opening, the hook bolt is engaged in the hook bolt slot. After the lock hook is rotated by a particular angle, the lock hook can move up and down due to the action of the eccentric structure. The hook bolt base, hook bolt and the eccentric structure together form an integral locking mechanism permits and facilitates various surface treatments to be applied to the lock body, such as spray coating or rubber sheathing.

In the foregoing embodiment, preferably, the hook bolt is a U-shaped elastic member. When the lock hook is inserted into the shackle opening, the U-shaped elastic member is elastically deformed and recovers from the deformation after the hook bolt is engaged in the hook bolt slot, thereby retaining the lock hook in the shackle opening.

In the foregoing embodiment, preferably, the eccentric structure is located above the hook bolt slot and is a plane formed by material cut from an outer surface of the lock hook.

Preferably, the cross section of the lock hook is circular shaped.

Preferably, at the two sides of the U shape of the U-shaped elastic member, one side is shorter than the other side. After assembly, the longer side is couples with the lock hook. The shorter side abuts against a side wall of the hook bolt base.

Preferably, the lock hook may further be provided a guiding chamfer below the hook bolt slot for guiding the lock hook to insert into the shackle opening, or the hook bolt may be provided with a guiding chamfer for guiding the lock hook to insert into the shackle opening.

Preferably, the cross section of the U-shaped elastic member is square shaped or rectangular shaped.

The present invention further provides a lock including a lock body, a lock cylinder, and the shackle apparatus according to any one of the foregoing embodiments.

According to the lock of the present invention, the hook bolt base, hook bolt and the eccentric structure together form an integral locking mechanism permits the lock hook be mounted to the lock body after the lock body is assembled. That is, mounting of the lock hook after assembly of the lock body can be achieved thus reducing the time and labor required to assemble the lock, while allowing and facilitating various surface treatments to be applied to the lock body. The lock of the present invention improves the production efficiency, reduces the defect rate, and facilitates various subsequent surface treatments of the lock body, thereby improving quality of the lock.

### BRIEF DESCRIPTION OF THE DRAWINGS

FIG. 1 is a partial exploded three-dimensional view of a laminated padlock according to an embodiment of the present invention;

FIG. 2 is a three-dimensional view of a hook bolt of the laminated padlock in FIG. 1;

FIG. 3A to FIG. 4B are schematic views illustrating a process of assembling the laminated padlock in FIG. 1, where FIG. 3B is an enlarged view of part A in FIG. 3A, and

FIG. 4B is an enlarged view of part B in FIG. 4A;

FIG. 5 is a partial three-dimensional view of the laminated padlock of FIG. 1 in a locked state;

FIG. 6 is a partial three-dimensional view of the laminated padlock of FIG. 1 in an unlocked state;

FIG. 7 is a three-dimensional view of a laminated padlock of the present invention;

FIG. 8 is a sectional view illustrating a use state of the laminated padlock of FIG. 7;

FIG. 9 is a sectional view along line C-C of FIG. 8;

FIG. 10 and FIG. 11 are respectively partially dissected perspective views of a rubber coated lock in a locked state and in an unlocked state according to another embodiment of the present invention;

FIG. 12 is a sectional view illustrating a use state of the rubber coated lock of FIG. 10; and

FIG. 13 is a sectional view along line D-D of FIG. 12.

### DETAILED DESCRIPTION

To make the objectives, features, and advantages of the present invention more comprehensible, preferred embodiments of the present invention are described in details below with reference to the accompanying drawings. It should be understood that the embodiments shown in the accompanying drawings are not intended to limit the scope of the present invention, but are merely intended to be used for describing the essence and spirit of the technical solutions of the present invention.

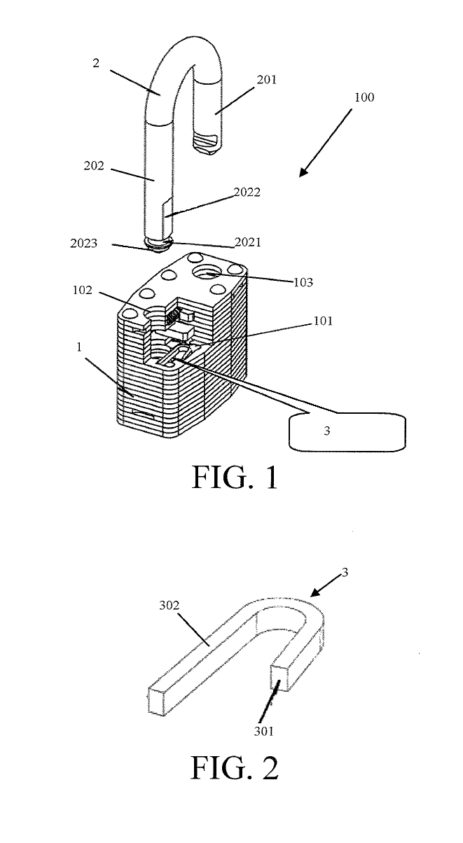

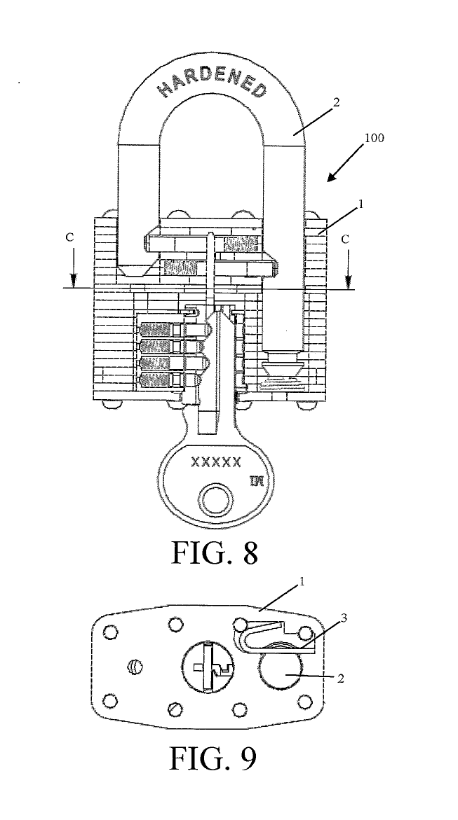

FIG. 1 is a partial exploded three-dimensional view of a laminated padlock 100 according to an embodiment of the present invention. As shown in FIG. 1, the laminated padlock 100 includes a lock body 1, a shackle apparatus, and a lock cylinder assembly (as shown in FIG. 8). The shackle apparatus includes a lock hook 2 and a hook bolt 3, the hook bolt 3 being disposed in a hook bolt base 101 of the lock body 1. After the lock body is assembled, the lock hook is inserted into a shackle opening 102 of the lock body 1 and is rotatable and able to move up and down in the shackle opening 102, thereby achieving locking and unlocking.

Specifically, the lock body 1 is formed by multiple interconnected metal sheets. The lock body is provided with the hook bolt base 101, the shackle opening 102 and a locking hole 103. Further, the hook bolt base 101 is located inside the lock body. One end 201 of the lock hook 2 is adapted to be locked in the locking hole 103 when the padlock is locked. The shackle opening 102 is connected with the hook bolt base 101 in such a way when the other end 202 of the lock hook 2 is inserted into the shackle opening 102 and coupled to the hook bolt 3, the lock hook 2 is rotatably connected to the lock body 1 is able to move up and down after being rotated by a certain angle.

The hook bolt 3 is an elastic member or an elastic structure. When the lock hook 2 is inserted into the shackle opening 102, the hook bolt 3 is elastically deformed to allow the insertion of the lock hook 2 and recovers from the deformation after the lock hook 2 is inserted, thereby retaining the lock hook 2 in the shackle opening 102.

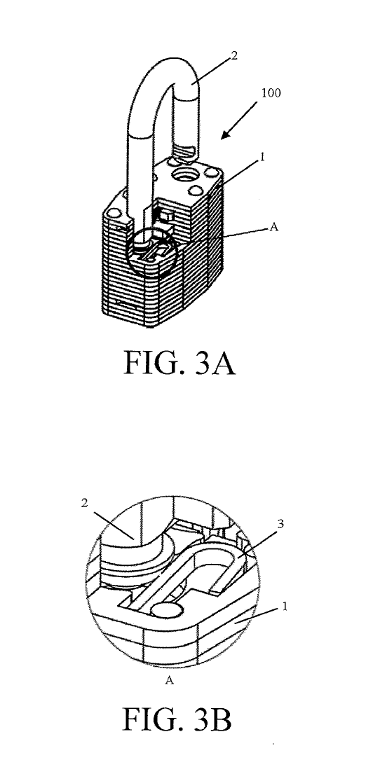

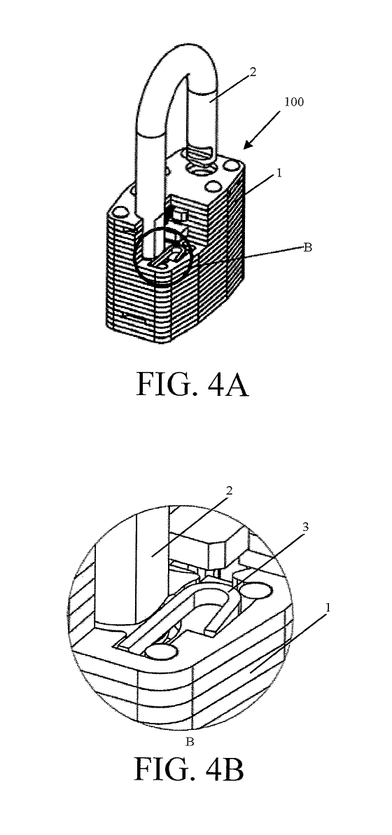

In the embodiment shown in FIG. 1, the hook bolt 3 is a U-shaped elastic member. As shown in FIG. 2, when the lock hook 2 is inserted into the shackle opening 102, the U-shaped elastic member is elastically deformed and recovers from the deformation after the U-shaped elastic member is engaged in a hook bolt slot 2021 at the end 202 of the lock hook 2 (to be further described below), thereby retaining the lock hook 2 in the shackle opening 102, as shown in FIG. 3A to FIG. 4B.

Preferably, among the two sides of the U shape of the U-shaped elastic member, one side 301 is shorter than the other side 302. After assembled, the longer side is fitted to the lock hook (to be further described below) and the shorter side presses against a side wall of the hook bolt base 101. However, it should be appreciated by a person of ordinary skill in the art that the two sides of the U-shaped elastic member may also have a same length.

Preferably, the cross section of the U-shaped elastic member may be square, rectangular, circular or of any other suitable shape.

In other embodiments, the hook bolt may be any suitable structure that can be deformed when the lock hook is inserted to allow insertion of the lock hook and recovery from deformation when the insertion of the lock hook is completed, so that the lock hook may be rotatably connected to the lock body.

Yet as shown in FIG. 1, the end of the lock hook 2 that is accommodated in the shackle opening 102 is provided with the hook bolt slot 2021 and an eccentric structure 2022. The eccentric structure 2022 is located above the hook bolt slot 2021. The cross section of the lock hook 2 being circular and the eccentric structure 2022 being a plane formed by cutting material from an outer surface of the circular lock hook.

Preferably, the lock hook is further provided with a guiding chamfer 2023 below the hook bolt slot 2021 for enabling the lock hook to be smoothly inserted into the shackle opening during insertion of the lock hook.

In another embodiment, the hook bolt 3 is provided with a guiding chamfer (not shown in the figure), which is also used for enabling the lock hook to be smoothly inserted into the shackle opening during insertion of the lock hook.

In the process of inserting the end 202 of the lock hook 2 into the shackle opening 101, the guiding chamfer compresses and deforms the hook bolt (which is a U-shaped elastic member in the embodiment shown in the figure). As the lock hook is further inserted downward, the hook bolt 3 enters the hook bolt slot 2021 while the hook bolt recovers from the deformation, that is, the hook bolt returns to the original state before the lock hook is mounted in order for the lock hook to retain in the lock body. This ensures that the lock hook will not be detached from the lock body when the padlock is locked or unlocked thereby achieving the effect of mounting of the lock hook after the lock body is assembled.

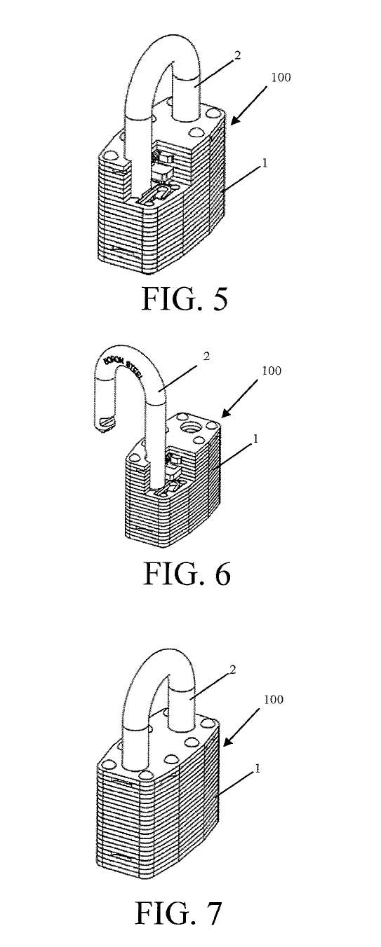

When the padlock is locked, the lock hook 2 is rotated by a certain angle. The eccentric structure 2022 is fitted to the hook bolt 3 so that the lock hook 2 can move downward while the other end of the lock hook 2 enters the locking hole 103 and thus achieving locking as shown in FIG. 5.

When the padlock is unlocked, the hook bolt slot 2021 on the lock hook allows the lock hook to rotate 360-degree as shown in FIG. 6.

According to the laminated padlock of the present invention, the hook bolt base, hook bolt and the eccentric structure together form an integral locking mechanism permits lock hook to be mounted to the lock body after the lock body is assembled (i.e., post-assembly mounted lock hook), making various surface treatments such as spray coating or rubber sheathing to be subsequently performed on the lock body of the laminated padlock possible. In addition, such structure of post-assembly mounted lock hook can also effectively reduce the cost and the defect rate and improve the productivity and the quality of manufacturing of locks.

FIG. 8 and FIG. 9 are sectional views illustrating a use state of the laminated padlock of FIG. 7. In the present invention, except the shackle apparatus all other parts and components of the laminated padlock, such as the lock body and the lock cylinder assembly, may use structures that are identical or similar to those of the corresponding parts and components of laminated padlocks disclosed in the prior art. For sake of clarity, the same will not be described herein in details.

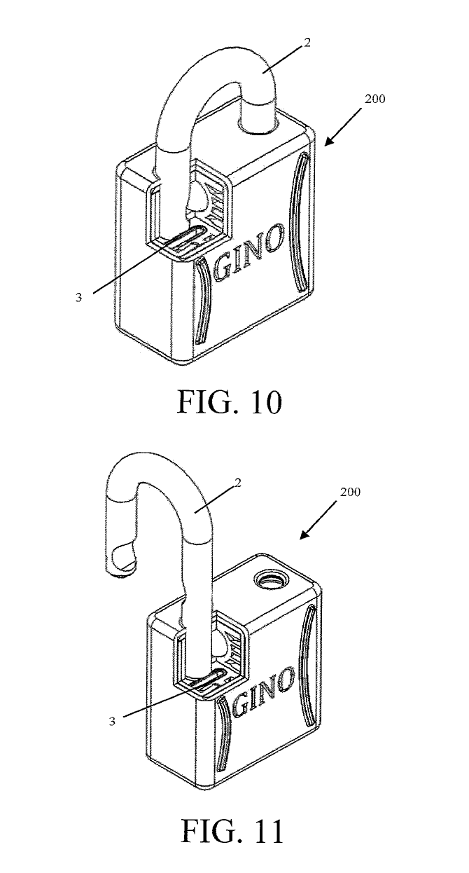

FIG. 10 and FIG. 11 are respectively partially dissected perspective views of a rubber coated lock 200 in a locked state and in an unlocked state according to another embodiment of the present invention. The rubber coated lock 200 includes a lock body, a shackle apparatus, a lock cylinder assembly and a rubber sleeve enclosing the lock body. The lock body may be an integral-type lock body a lock body formed by combining multiple metal sheets or plastic sheets The lock cylinder assembly may be any suitable lock cylinder assembly known in the art which will not be described herein in details.

The shackle apparatus of the embodiment shown in FIG. 10 and FIG. 11 is the same as the shackle apparatus of the embodiment shown in FIG. 1 to FIG. 9. That is, the shackle apparatus includes a lock hook 2 and a hook bolt 3, wherein the hook bolt is disposed in a hook bolt base of the lock body. After the lock body is assembled, the lock hook may be inserted into a shackle opening of the lock body, rotated and moved up and down in the shackle opening, thus achieving locking and unlocking.

In this embodiment, the structures of the lock hook and the hook bolt of the shackle apparatus, their the assembly and positional relationship with the lock body are identical to those of the lock hook and the hook bolt in the previous embodiment and will not be further described herein in details.

Referring to the rubber coated lock of the present invention, the hook bolt base, hook bolt and the eccentric structure together form an integral locking mechanism permits the lock hook to be inserted into the lock body after the lock body is assembled, making the application of various surface treatments, such as spray coating or rubber sheathing, to the lock body possible. The present invention greatly simplifies the assembly of the rubber coated lock, improves the assembly efficiency and reduces the rate of defect.

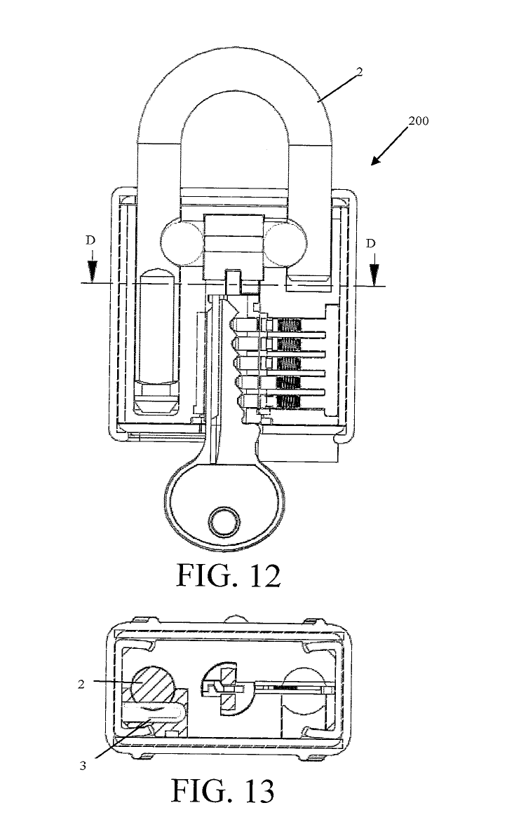

FIG. 12 and FIG. 13 are sectional views illustrating a use state of the rubber coated lock of FIG. 10. In the present invention, all other parts and components (except the shackle apparatus) of the rubber coated lock such as the lock body and the lock cylinder assembly may employ structures that are identical or similar to those of corresponding parts and components of a rubber coated lock in the prior art. For sake of clarity, the same will not be described herein in details.

Although the preferred embodiments of the present invention have been described in the above, it should be appreciated that a person skilled in the art can make various alterations or modifications to the present invention according to the teachings stated in the present invention. Such equivalents also fall within the scope as defined by the appended claims of this application.

What is claimed is:

1. A lock comprising a lock body and a shackle apparatus, the lock body being provided with a shackle opening and a locking hole, wherein:
the lock further comprises a lock hook and a hook bolt, one end of the lock hook being adapted for being inserted and locked in the locking hole when the lock is in a locked state;
the lock body is further provided with a hook bolt base for accommodating the hook bolt, the hook bolt base being connected with the shackle opening; and
the hook bolt and the lock hook are configured so that after the lock body is assembled, the other end of the lock hook can be inserted into the shackle opening and fitted to the hook bolt such that the lock hook is rotatably connected to the lock body, the lock hook can move up and down after being rotated by a certain angle.

2. The lock according to claim 1, wherein the hook bolt is an elastic member such that when the lock hook is inserted into the shackle opening the hook bolt is elastically deformed to allow the insertion of the lock hook and recovered from the deformation after the lock hook is inserted, thereby retaining the lock hook in the shackle opening.

3. The lock according to claim 1, wherein the end of the lock hook being accommodated in the shackle opening is provided with a hook bolt slot and an eccentric structure such that when the lock hook is inserted into the shackle opening, the hook bolt can be engaged in the hook bolt slot, after being rotated by a particular angle the lock hook can move up and down under the action of the eccentric structure.

4. The lock according to claim 3, wherein the hook bolt is a U-shaped elastic member, when the lock hook is inserted into the shackle opening the U-shaped elastic member is elastically deformed and recovered from the deformation after the hook bolt is engaged in the hook bolt slot, thereby retaining the lock hook in the shackle opening.

5. The shackle apparatus according to claim 3, wherein the eccentric structure is located above the hook bolt slot, the eccentric structure is a plane formed by removing material from an outer surface of the lock hook.

6. The lock according to claim 4, wherein the U-shaped elastic member having two sides, one of the two sides is shorter than the other side, the longer side is fitted to the lock hook and the shorter side presses against a side wall of the hook bolt base after assembly.

7. The lock according to claim 5, wherein the lock hook is further provided with a guiding chamfer below the hook bolt slot for guiding the lock hook to enter the shackle opening, or the hook bolt is provided with a guiding chamfer for guiding the lock hook to enter the shackle opening.

8. The lock according to claim 6, wherein the cross section of the U-shaped elastic member is square or rectangular shaped.

9. (canceled)

10. The lock according to claim 1, wherein the lock is a laminated padlock.

11. A lock comprising a lock body and a shackle apparatus, the lock body being provided with a shackle opening, a locking hole and means for locking the shackle apparatus, wherein:
the shackle apparatus comprises a lock hook and two ends, a first end being adapted for inserting to the locking hole and locked by the locking means, and a second end of the lock hook being adapted for inserting to the shackle opening;
the lock body is further provided with a resilient hook bolt being one-way engageable with the second end of the shackle apparatus through the shackle opening, and
the second end of the shackle being provided with a guiding chamfer and a circumferential hook bolt slot, the hook bolt engages in the hook bolt slot in an unlocked state and prevents the shackle apparatus from detaching from the lock body.

12. The lock according to claim 11, the shackle apparatus being rotatable about the shackle opening in the unlocked state.

13. The lock according to claim 11, the second end further comprises an eccentric structure adjacent to the hook bolt slot, as the shackle apparatus further moves towards the lock body to achieve locking, the hook bolt engages with and abuts the eccentric structure.

14. The lock according to claim 13, the eccentric structure is a plane formed by removing material from an outer surface of the second end of the shackle apparatus, wherein the plane is flush with a bottommost point of the hook bolt slot.

15. The lock according to claim 11, wherein the hook bolt is situated in a hook bolt base provided in the lock body, the hook bolt base being spatially connected to the shackle opening.

16. The lock according to claim 14, wherein the lock is a laminated padlock.

17. A method of assembling a lock, wherein the lock is assembled in the sequence of:
a) providing a shackle apparatus and a lock body according to claim 11;
b) completing the assembly of the lock by assembling a hook bolt and a locking means to the lock body; and
c) inserting an end of the shackle apparatus through a shackle opening provided on the lock body and engaging the end of the shackle apparatus with the hook bolt.

18. The method of assembling a lock according to claim 17, wherein the method further comprises the step of applying a surface treatment to the lock body before step c).

19. The method of assembling a lock according to claim 18, wherein the surface treatment is spray coating.

20. The method of assembling a lock according to claim 18, wherein the surface treatment is rubber sheathing.
